(19) United States
(12) Patent Application Publication
(10) Pub. No.: US 2017/0206214 A1
(43) Pub. Date: Jul. 20, 2017

(54) SYSTEM AND NETWORK PLATFORM FOR ENABLING THE FORMATTING, MODIFICATION, AND ORGANIZATION OF FILES BASED ON ACCOUNT CLASSES AND HIERARCHY RULES USING A VISUAL REPRESENTATION AND MANIPULATION OF PARAMETERS, SUBPARAMETERS, AND DEMARCATIONS

(71) Applicant: Corey Francis Stedman, White Plains, NY (US)

(72) Inventor: Corey Francis Stedman, White Plains, NY (US)

(21) Appl. No.: 15/406,897

(22) Filed: Jan. 16, 2017

Related U.S. Application Data
(60) Provisional application No. 62/279,090, filed on Jan. 15, 2016.

(51) Int. Cl. G06F 17/30; G06F 17/21; G06F 17/24; G06F 3/0484

(52) U.S. Cl. CPC G06F 17/30112; G06F 17/30106; G06F 3/04847; G06F 17/211; G06F 17/24; G06F 3/0482

(57) ABSTRACT

A system and platform for enabling the modification and organization of enterprise documents via a network of one or more computer systems according to user choice while imposing limitations based on user class and document uniformity integrity. Effected via a visual framework of graphical parameters, sub-parameters, and demarcations.

### PRIORITY CLAIM

This application claims priority to U.S. Provisional Application Ser. No. 62/279,090, filed Jan. 15, 2016. The above references application is incorporated herein by reference as if restated in full.

### INTRODUCTION

Users of enterprise software must simultaneously adapt to a uniformity of filing and access based on the needs of their institution or corporation, but must be able to control and access documents relevant to their work according to what best facilitates their productivity. However, files are typically installed on a server and merely accessed by parties remotely over a network, and if the files are to be managed by multiple workers, accountability and centralization are both required. The disclosure provided enables users to organize files without violating the preferences or needs of other workers.

### SUMMARY

The platform comprises a set of algorithms coupled to a user interface.

In one aspect, the platform provides for the creation of user accounts and the storing of user account information in a user account database.

In one embodiment of this aspect, the platform provides for adding one or more articles of user information to the user account database. The platform may provide a user interface enabling a user to sign up for a user account by sending one or more articles of information to the platform, such as the user's first and last name, a user name, a password, and one or more security questions and/or answers to those security questions. The platform may add a user account to the user account database, and associate these articles of information with that user account.

In another embodiment, users may be assigned a UserClass by the platform. The UserClass may be determined based on one or more of the articles of information provided to the platform by the user. In another embodiment, a user may assign himself or herself a UserClass.

The platform provides a user interface permitting a user to configure the way Files and Folders are named, modified, saved, and organized. Some Files may comprise Content—for example, they may be text documents and have a visible text component, or images with an image component. Collectively, Files and Folders will be referred to as “Items”.

In one aspect, the platform provides a user interface permitting a user to select the Format of Parameters that the platform will use to name, rename, and organize an Item. Parameters may include User, UserClass, Device, Date, FileType, Category, Subject, and Version, the Format comprising the ordering of those Parameters. For example, an Item may have a Format such that the Parameters are arranged “User UserClass Device Date FileType Category Subject Version”, or any other ordering thereof.

A Parameter may be comprised of Sub-Parameters, and the Format may comprise the ordering of these Sub-Parameters as well. For example, the Sub-Parameters of the Date Parameter may include Day, Month, Year, and perhaps even Time, which may itself be composed of Sub-Parameters Hour, Minute, Second, Period. The Date Parameter may have a Format such that the Sub-Parameters are arranged “Day Month Year Hour Minute Second Period”. Here, “Period” may be instantiated (a term which will be discussed below) by either “AM” or “PM”.

The Format may include the omission of a Parameter or Sub-Parameter as well. For example, a Format may be “Subject Day Month Year”, thereby omitting User, UserClass Device, Category, FileType, and Version. The Format may also include a demarcation between the Parameters and/or Sub-Parameters. The demarcation may comprise a symbol or space, or a capitalization of the first and/or remaining letters in a Parameter or Sub-Parameter. For example, the Format may be “Subject Day-Month-Year Hour:Minute:Second”, “SubjectVersion”, or “Subject Version”.

The Format may also include the Form of Parameters and/or Sub-Parameters, for these may be expressed in different ways. For example, the Sub-Parameter Month may be expressed in the Form of either a number or name, viz., “6” or “June”. Likewise, Hour may be expressed as a twelve or twenty four hour cycle, viz., “14” or “2”. In the latter case, it is suggested that the Period be included in the Format to accurately reflect the Time.

Each unique Format may be assigned a different Format Code by the platform or the user. These assignations may precede any selection or assembling of any given Format by the user: rather, they may be pre-entered into the platform.

In one embodiment, the platform will display a set of unique Formats on the user interface, and the user may select one of the Formats. In another embodiment, the platform will display Parameters, and the user may select one or more of the Parameters; once the Parameters are selected, the platform displays unique Formats that modify and arrange those Parameters, thereby limiting the number of Formats displayed to the user. The user may then select from this more limited selection of Formats.

In one version of this embodiment, when a Parameter is selected by the user, the platform will display the Sub-Parameters that comprise that Parameter; the user can then select the Sub-Parameters that the user desires to be included in the Format. In another version of this embodiment, when either a Parameter or Sub-Parameter is selected by the user, the platform will display the Forms that may comprise it; the user can similarly select the Form that the user desired to be included in the Format.

In yet another embodiment, the platform will display Parameters, Sub-Parameters, and demarcations, and the user may select from among these and arrange them. The arrangement may be effected by a drag-and-drop technique applied to an area of the user interface. Capitalization may be effected by double-clicking or otherwise alternatively selecting any of the Parameters or Sub-Parameters. Form may be effected by in some manner double clicking or otherwise alternatively selecting any of the Parameters or Sub-Parameters.

In one version, while the user may drag and drop the desired Parameters and/or Sub-Parameters in a desired order, the demarcations are determined by the platform. In another version, the Form is determined by the platform.

In one aspect, when a Format is selected or assembled, the platform may associate the Format with an Item. The Item Name of the Item is then saved according to the Format. In one embodiment, the Format may be saved by the user for future use. Instead of selecting or assembling a new Format, the user may load a previously saved Format, which may then be associated with the new Item.

The Item Name, although technically separate from the Format of an Item, is still governed by that Format. As such, two distinct Items may have the same Format even though their Item Names will likely be distinct.

As discussed, the Format is the selection, arrangement, and Form of Parameters and/or Sub-Parameters. The Item Name is comprised of instantiations of any given Parameter or Sub-Parameter. For example, for the Format “Subject Date”, one instantiation for a given Item Name may be “Homework 6-28-1987”, while another instantiation may be “Mortgage 5-13-2007”. Two other instantiations that are identical to the two preceding except in Form are “Homework June-28-1987” and “Mortgage May-13-2007”.

A Default Instantiation comprises a term or the result of a formula or algorithm defined by the platform or user which will support any Parameter or Sub-Parameter deemed necessary by the platform or user but which otherwise lacks an Instantiation.

The Present Date and the Present Time correspond to the current date or time identified by the system running the platform. The Present Date may comprise a Present Day, a Present Month, and a Present Year, just as the Present Time may comprise a Present Hour, a Present Minute, a Present Second, and a Present Period.

The Present Device refers to the device, such as a laptop or mobile device, which is currently running the platform, and may comprise a platform derived name, or one given by a user.

The Present User corresponds to a User Name that has been assigned or selected by the user currently using or logged into the platform or computer running the platform. The Present UserClass corresponds to the class in which the user currently is listed.

The Present Folder refers to the Folder in which a given Item is currently saved or stored.

The Present Format refers to the Format of a given Item currently selected or operated upon by the platform or the user.

The Recognized Format Regime refers to a set of Formats identified by a device, operating system, and/or platform as “recognized” as the default for the device, operating system, and/or platform. Accordingly, any Format included in the Recognized Format Regime is a Recognized Format, and any Format not included in Recognized Format Regime is an Unrecognized Format.

In one embodiment, the platform will recognize an equivalence between two Instantiations that differ only as to the Form and/or Format of designated Parameter(s) and/or Sub-Parameter(s). Such Instantiations are considered Equivalent Instantiations.

The user and/or platform may select what Parameters or Sub-Parameters are visible in the user interface.

In one embodiment, the platform provides a user interface enabling the user to assign one or more Conditions to an Action. An Action may comprise a Treatment, which modifies an Item's Item Name, an Organizational Rule, which modifies an Item's location in a directory or database, or a Hierarchical Rule, which will be explainer later. Conditions comprise events that may be selected and/or modified by the user using the user interface. It will be easier to explain them by the following examples:

An Item has been created.

The Content of an Item has been modified.

An Item has been saved by the user.

An Item has been closed by the Present User.

An Item has been auto-saved by a content manipulation software.

The Content of an Item has NOT been modified for a given number of days.

The Instantiation of the Version Parameter of an Item is less than the Instantiation of the Version Parameter of another Item that has one or more other Instantiations of Parameters in common.

The Instantiation of the User Parameter of an Item matches the Instantiation of the User Parameter of a Folder.

The Instantiation of the FileType Parameter of an Item matches the Instantiation of the FileType Parameter of a Folder.

The Instantiation of the Category Parameter of an Item matches the Instantiation of the Category Parameter of a Folder.

The Instantiation of the Subject Parameter of an Item matches the Instantiation of the Subject Parameter of a Folder.

The Instantiation of the Year Sub-Parameter of an Item matches the Instantiation of the Year Sub-Parameter of a Folder.

The Instantiation of the Month Sub-Parameter of an Item matches the Instantiation of the Month Sub-Parameter of a Folder.

The Instantiation of the Month Sub-Parameter of an Item does not match the Present Month Sub-Parameter.

The Instantiation of the Year Parameter of an Item does not match the Present Year Sub-Parameter.

The Instantiation of the Date Parameter of an Item is a given number of days old.

The Instantiation of a Designated Parameter and/or Sub-Parameter matches a Default Instantiation.

The Instantiation of the lime Parameter of an Item is a given length of time old.

The Instantiation of the User Parameter does not match the Present User.

The Instantiation of the UserClass Parameter does not match the Present UserClass.

The Present UserClass is a Limited UserClass, a Limited UserClass having fewer rights than an UnLimited UserClass.

The Instantiation of the Device Parameter does not match the Present Device.

The Present Time has reached 12:00 AM or 24:00.

The Present User mandates that the Conditions for an Action have been met.

The Present Format is an Unrecognized Format.

The Present Format lacks one or more Parameters and/or Sub-Parameters found in a designated Recognized Format.

The Present Folder is designated by the user as a special Condition.

It should be understood that these exemplary conditions comprise a selection from among which there may be many more that have merely not been stated here.

In one embodiment, the platform provides a user interface enabling the user to assign a Treatment to an Item. A Treatment comprises an Action executed by the platform to name, rename, or save an Item if one or more Conditions are met. As such, Treatments are coupled to one or more Conditions selected either by the platform or by the user. Examples of Treatments include:

Change the Instantiation of the Date Parameter of an Item to the Present Date.

Change the Instantiation of the Time Parameter of an Item to the Present Time.

Add 1 to the Instantiation of the Version Parameter of an Item.

Change the Instantiation of the User Parameter of an Item to the Present User.

Change the Instantiation of the Device Parameter of an Item to the Present Device.

Change the Format of an Item from the Present Format to another Format.

Push the Instantiation of the Date Parameter to the following day.

Change the Format of an Item from the Present Format to a Recognized Format.

Add Default Instantiations for one or more Parameter(s) and/or Sub-Parameters.

Add Present Instantiations for one or more Parameter(s) and/or Sub-Parameters.

Change the File Type to Read-Only.

Change the File Type to Read & Write.

In one aspect, the platform provides a user interface enabling the user to select or assemble an Organizational Rule. An Organizational Rule comprises an Action executed by the platform if one or more Conditions. This Action may comprise creating and naming a Folder, and/or moving an Item from one location in a directory or database to another location. Organizational Rules are coupled to one or more Conditions either by the platform or by the user. Examples of Organizational Rules include:

Save the Item to the Present Folder.

Save the item to a Compression Folder and Compress the Item.

Move/Save the Item to a Folder whose Item Name matches the [Designated Parameter(s) and/or Sub-Parameter(s)] of the Item.

Create a Folder whose Item Name matches the [Designated Parameter(s) and/or Sub-Parameter(s)] of an Item and move/save that Item to that Folder.

Create a Folder whose Item Name matches the [Designated Parameter(s) and/or Sub-Parameter(s)] of an Item, add “Archive” to the Instantiation of the [Designated Parameter] and move/save that Item to that Folder.

Copy/save a Folder from a first server to a second server whose Item Name matches the [Designated Parameter(s) and/or Sub-Parameter(s)] of an Item, and copy/save that Item from the first server to the copied/saved Folder on the second server.

In one aspect, the platform provides a user interface enabling the user to select or assemble an Hierarchical Rule. A Hierarchical Rule comprises an Action executed by the platform if one or more Conditions.

Make an Item Visible

Make an Item Invisible

Make an Item Read-Only.

While Actions are divided between Treatments, Organizational Rules, and Hierarchical Rules, the category of an Action is not absolutely significant, and a Rule categorized above under an Organizational Rule may also be categorized under a Hierarchical Rule, etc.

The Actions, including Treatments and Organizational Rules, and Conditions that trigger them, provide a dynamic and user-friendly power over the Files and Folders. While there are countless combinations of Actions and Conditions, here are a few relevant ones.

Backup. Files and Folders can be backed up automatically by the platform according to time intervals designated by the user or platform.

Conversion. The Formats of Files and Folders can be changed to the Recognized Formats of a given system, thereby allowing that system to run the Files and Folders.

Privacy/Control. A user may control who can access/modify a given Item by Conditioning the ability to access and/or modify that Item based on UserClass.

### BRIEF DESCRIPTION OF THE DRAWINGS

FIG. 1 shows a flowchart of an exemplary process embodiment of the formatting system platform.

FIG. 2 shows a flowchart of an exemplary process embodiment of the formatting system platform.

FIG. 3 shows a flowchart of an exemplary process embodiment of the formatting system platform.

FIG. 4 shows a flowchart of an exemplary process embodiment of the formatting system platform.

FIG. 5 shows a flowchart of an exemplary process embodiment of the formatting system platform.

FIG. 6 shows a flowchart of an exemplary process embodiment of the formatting system platform.

FIG. 7 shows a flowchart of an exemplary process embodiment of the formatting system platform.

FIG. 8 shows a flowchart of an exemplary process embodiment of the formatting system platform.

FIG. 9 shows an exemplary computer system.

### DETAILED DESCRIPTION

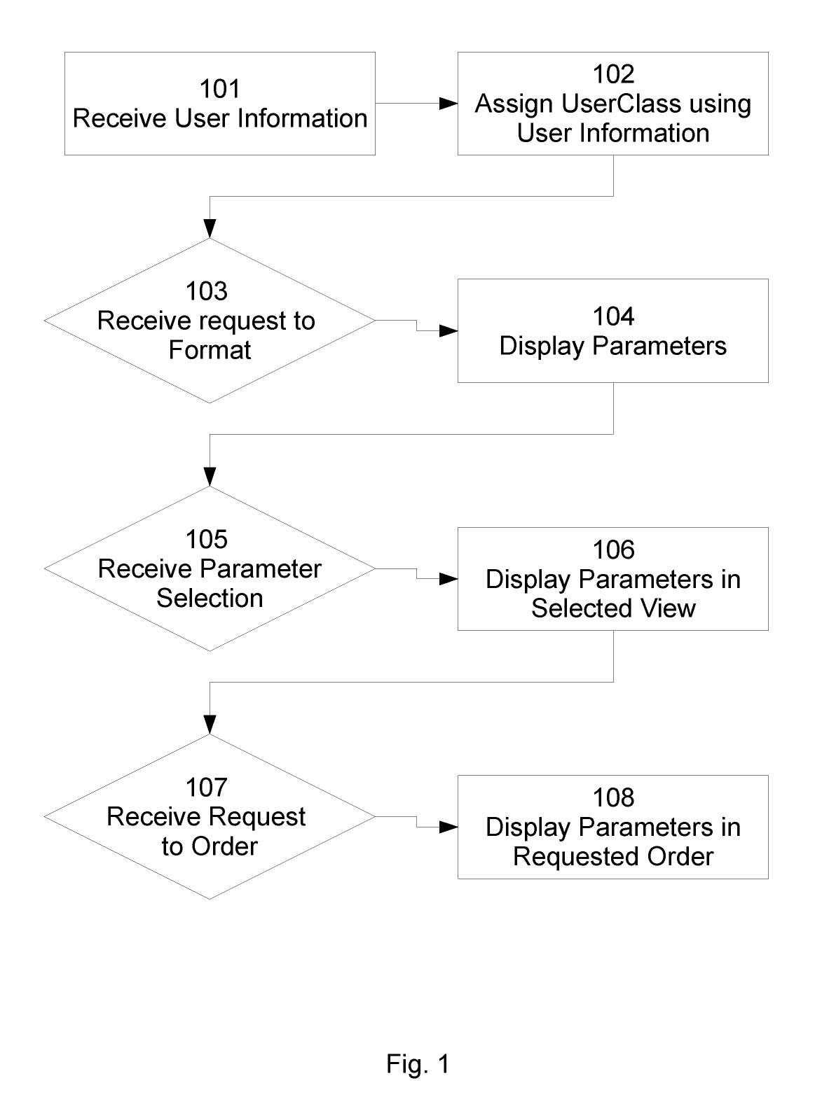

In FIG. 1, the user may provide and the platform may receive user information 101. The user information may include a username and password, as well as the user's name and other identification details. The identification details may include the user's place or position in an organization. Alternatively, the identification details may include limitations on what the user can do on the platform. For example, if the user is a child, then the platform may only permit access to certain documents by assigning a UserClass to the user 102.

The user may submit a request to create or modify the Format of Parameters in Item Names 103. This request may be effected by formally selecting a Format Request in the user interface, and may be limited to a given Item by in indicating the given Item, or may be effected globally across a range of Formats. The platform will display a set of Parameters 104. The user may then select and the platform may receive a Parameter Selection. The selected Parameters may then be displayed in a Selected View 105, which indicates to the user that they are selected. The Selection View may constitute a highlighting of Parameters or a negative highlighting of unselected Parameters.

The user may submit a request to and the platform may receive a request to arrange or Order the Parameters 107. The ordering may occur via drag-and-drop actions or by a formal assignation of an order number by the user. The Parameters are then displayed in the requested Order 108.

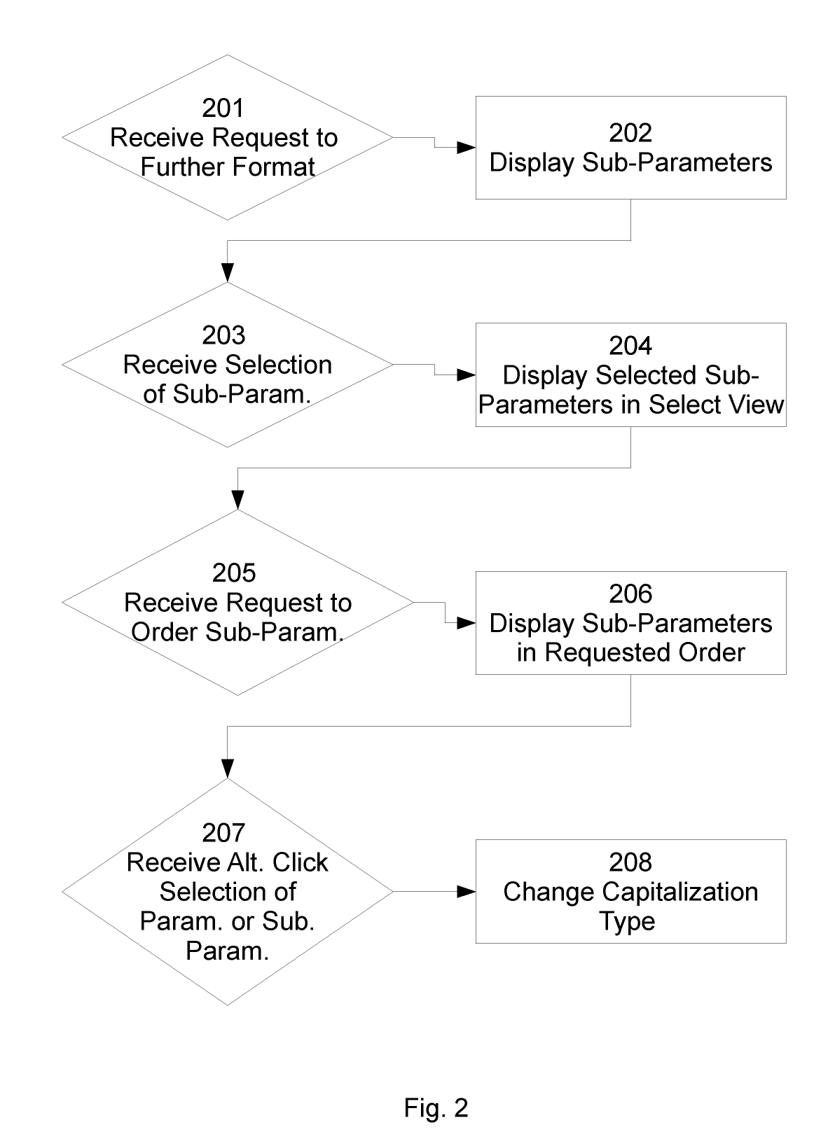

In FIG. 2, the user may request and the platform may receive the request to further Format or Format the Sub-Parameters 201. This may be effected by receiving a selection from the user of a given Parameter or otherwise indicating the Parameter block the user wishes to further Format. The platform will then display the Sub-Parameters that comprise a Parameter 202. The platform may receive from the user a selection of Sub-Parameters to include in the Format 203, and then may display the selected Sub-Parameters in a Selection View 204. The user may request to arrange or Order the selected Sub-Parameters 205. The ordering may occur via drag-and-drop actions or by a ormal assignation of an order number by the user. The Sub-Parameters are then displayed, with or without the higher level Parameters, in the requested Order 206. The user may also select or otherwise indicate that a given Parameter or Sub-Parameter is to be fully capitalized, uncapitalized, or to have its first letter capitalized 207. This may be effected by selecting or alternatively selecting the Parameter or Sub-Parameter. The platform may then change the Capitalization Type 208.

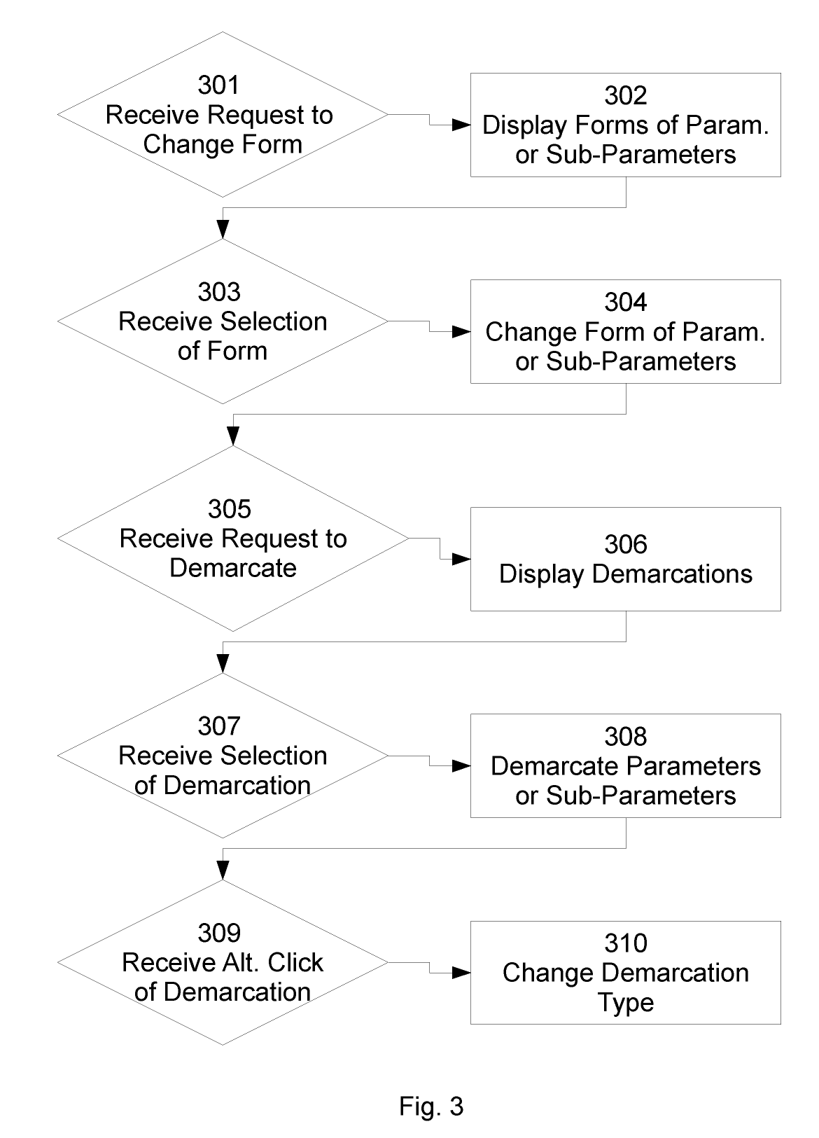

In FIG. 3, the user may submit and the platform may receive a request to change the Form of a Parameter or Sub-Parameter 301. This request may be effected by selecting a given Parameter or Sub-Parameter. The platform may then display the one or more Forms of a Parameter or Sub-Parameter 302. The Forms may be displayed adjacently, or in a drop-down or scroll menu. The Forms may appear in place of or adjacent to the Parameter or Sub-Parameter they modify. The platform may then receive a user selection of a given Form 303, and may then change the Form of the selected Parameter or Sub-Parameter 304.

The user may submit and the platform may receive a request to demarcate the Parameters and/or Sub-Parameters 305. Demarcations may be displayed 306, between or external to the Parameters and/or Sub-Parameters. The platform may receive a selection of a given Demarcation 307. That Demarcation may then be displayed between the Parameters and/or Sub-Parameters 308. The Demarcation may be selected for each space in between Parameters and/or Sub-Parameters. In one variation, once a Demarcation is selected, the user may select or alternatively select a given Demarcation 309 in order to change the Demarcation Type 310.

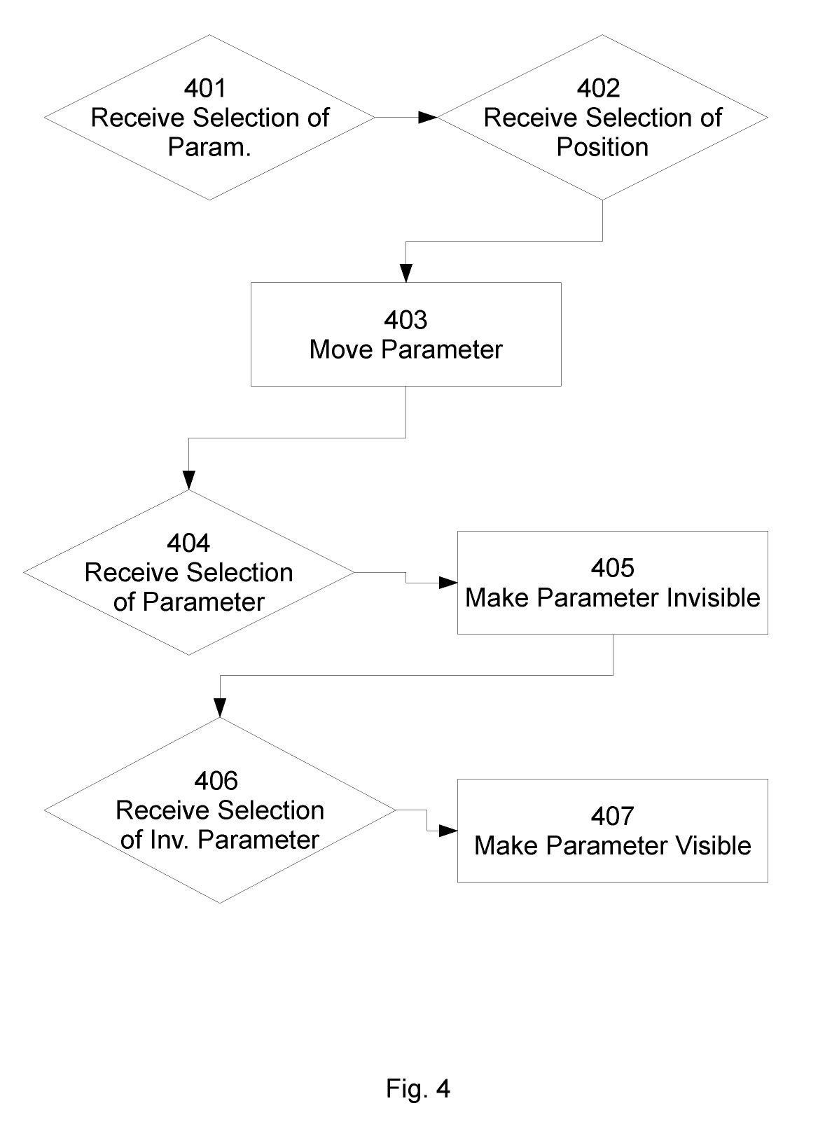

In FIG. 4, the platform may receive a user selection of a Parameter 401, followed by a user selection of a position with respect to other positions occupied by Parameters 402. The platform then moves the Parameter from the old position, if it was previously in a position, into the selected position 403.

The platform may receive a user selection of a Parameter 404, then the platform may make the parameter invisible 405. This invisibility may be a mere transparency in a selection phase, but then once the Format is determined and assigned, the selected Parameter may be not displayed. The platform may receive an alternate or repeated selection of the Parameter given an invisible or transparent status 406, and may then remove the invisible or transparent status, thus displaying the Parameter 407.

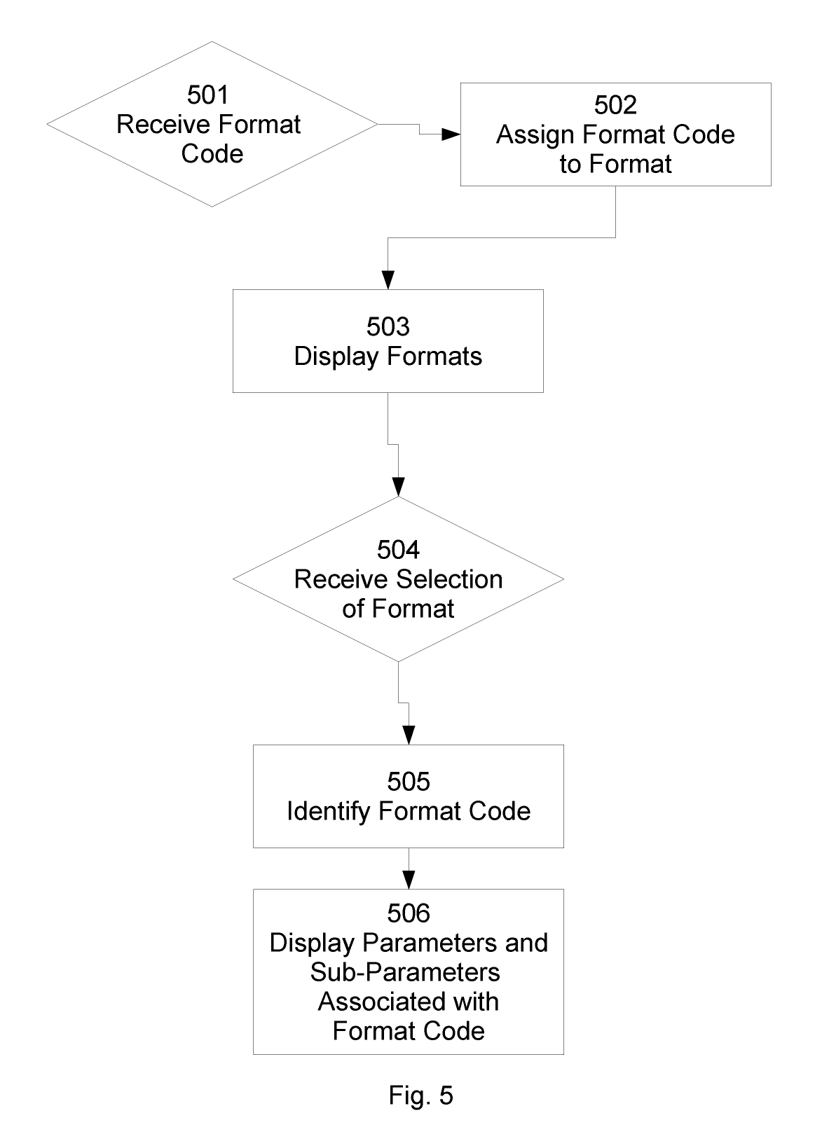

In FIG. 5, the platform receives a Format Code selection 501. The Format Code may be a name create by the platform using the Format Parameters, or may be entered by the user. The Format Code may then be assigned to the Format 502.

The platform may display the Format Codes, the Formats, or instantiations of the Formats 503. If the platform receives a user selection of a Format Code 504, then the platform may identify the Format associated with the Format Code 505 and display the Format or instantiations of the Format with respect to its Parameters and Sub-Parameters 506.

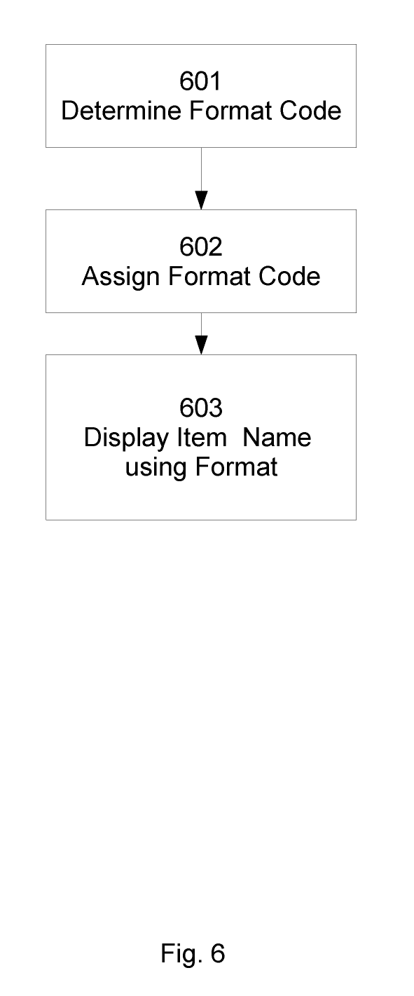

In FIG. 6, the platform may determine a Format for a given Item by identifying its previous Format, a user selection of a new Format, or a default Format used by the platform 601. The platform may then assign that Format to the given Item 602 and display the Item Name using the Format 603.

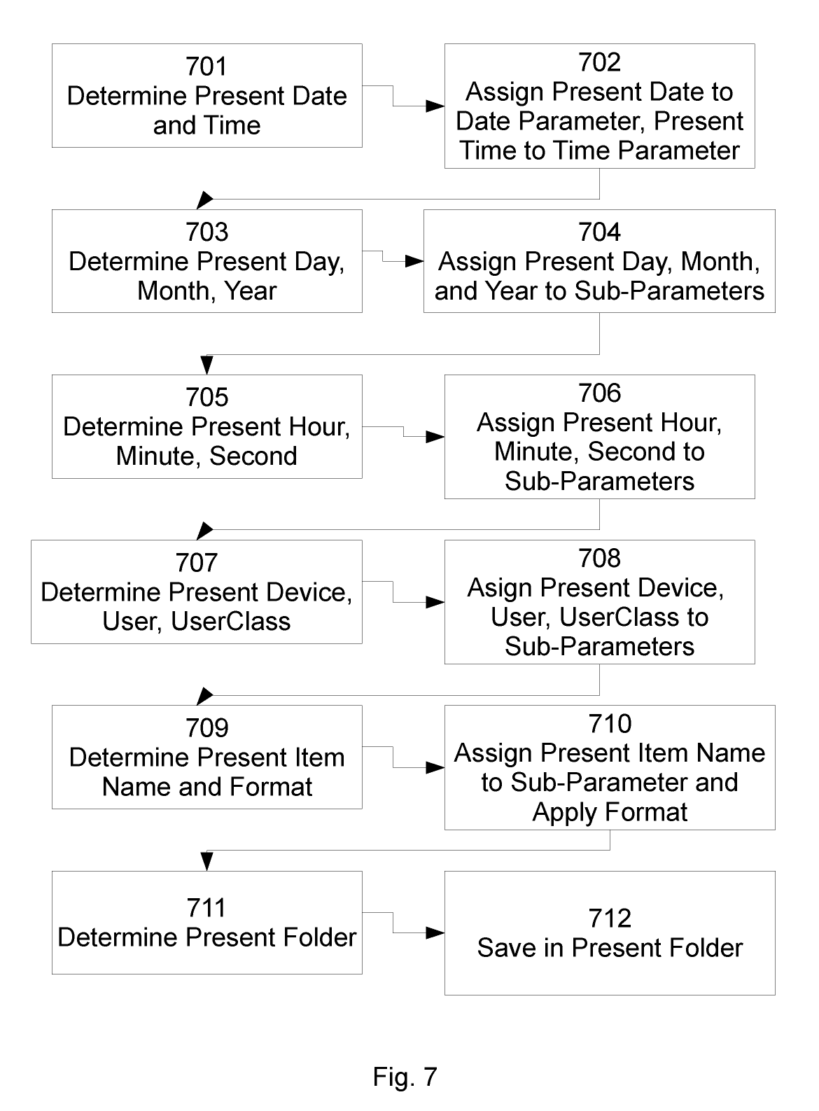

In FIG. 7, the platform determines the Present Date and Present Time by using the system clock 701. Then the platform assigns the Present Date to the Date Parameter and the Present Time to the Time Parameter 702. Once the instantiation details of the Item are complete, the Item Name is displayed with the Present Date for the Date Parameter and the Present Time for the Time Parameter, in combination with the other instantiations. Similarly, the platform may determine the Present Day, Present Month, and Present Year 703, and assign them to the Day, Month, and Year Sub-Parameters 704. The platform may determine the Present Hour, Present Minute, and Present Second 705 and assign them to the Hour, Minute, and Second Sub-Parameters 706. The platform may determine the Present Device by accessing the system information and the Present User and Present UserClass by accessing the account or login information stored in the system 707. The platform may assign the Present Device, User, and UserClass to the relevant Sub-Parameters 708.

Similarly, the platform may determine the Present Item Name and Present Format by accessing the Item file information, as stored on the platform or system or in the file itself. 709 The Present Format and Present Item Name may be gleamed from the file as previously saved. The platform may then assign the Present Item Name to the Parameter(s) and arrange the Parameters according to the Format 710. The platform may determine the Present Folder in which the Item was previously saved, or by searching through the Item Name as modified by the user 711. The platform may then save the Item in that Folder associated with the Present Folder.

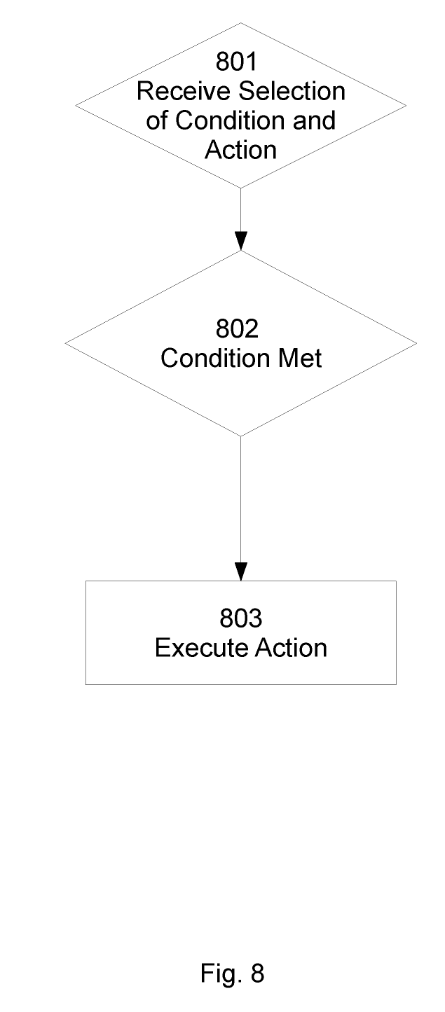

In FIG. 8, the platform my receive a user selection of a Condition and an Action 801. The platform, upon determining that the Condition is met 802, may execute the Action 803.

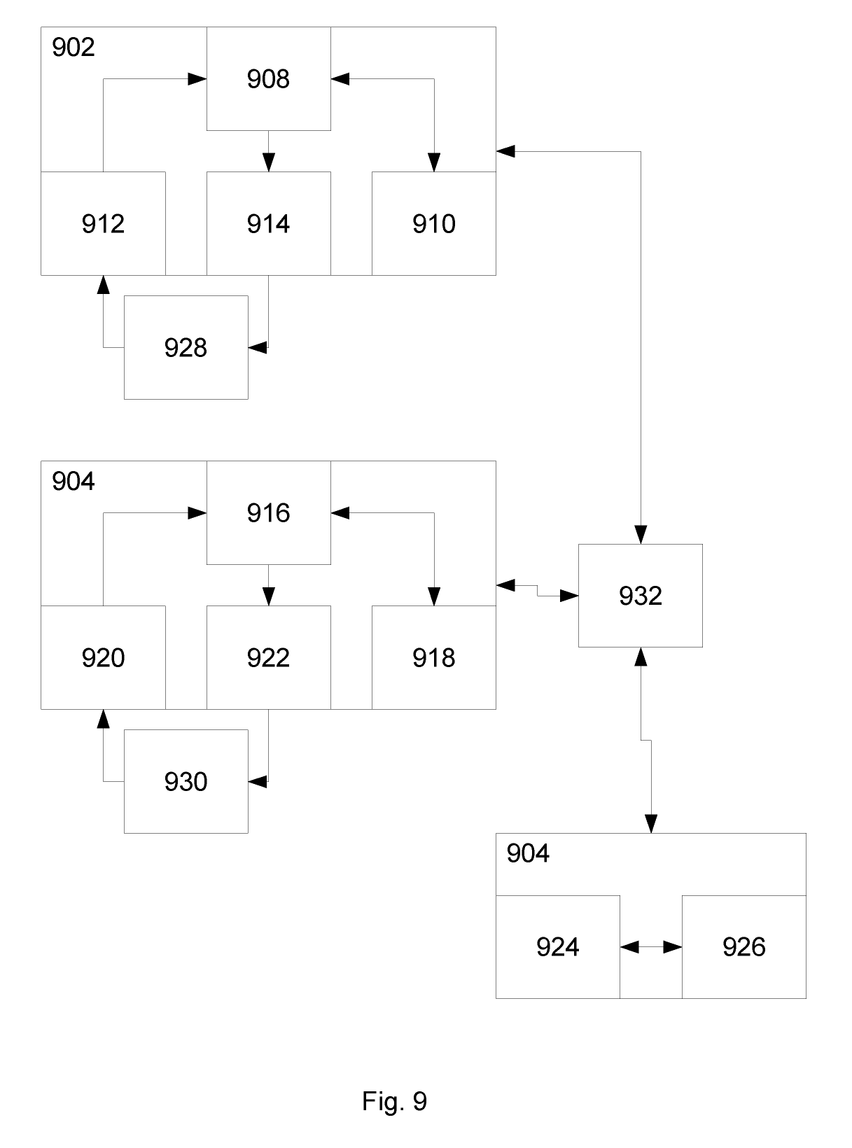

As shown in FIG. 9, the system may include a first computer system 902, a second computer system 904, and a third computer system 906, the first computer system comprising a first processor 908, a first computer storage memory 910, a first set of one or more input devices 912, and a first display device 914, the second computer system comprising a second processor 916, a second computer storage memory 918, a second set of one or more input devices 920, and a second display device 922, the third computer system comprising a third processor 924 and a third computer storage memory 926, the first computer system operated by a first user 928, the second computer system operated by a second user 930, the first computer system, the second computer system, and the third computer system connected to a network 932 of one or more computer systems.

1. A system including a first computer system, a second computer system, and a third computer system, the first computer system comprising a first processor, a first computer storage memory, a first set of one or more input devices, and a first display device, the second computer system comprising a second processor, a second computer storage memory, a second set of one or more input devices, and a second display device, the third computer system comprising a third processor and a third computer storage memory, the first computer system operated by a first user, the second computer system operated by a second user, the first computer system, the second computer system, and the third computer system connected to a network of one or more computer systems;
one or more of the processors programmed to:
receive a first set of user information relevant to the first user from the first user using the first set of input devices and determine a user class using the first set of user information,
receive a user request from the first user using the first set of one or more input devices to format and display using the first display device a set of parameters, a parameter being a category of information appearing in a filename, the set of parameters including date, time, and user name parameters;
receive a user selection from the first user using the first set of one or more input devices of one or more parameters from the set of parameters,
receive a user request from the first user using the first set of one or more input devices to order the one or more parameters from the user selection of the one or more parameters and display on the first display device an arrangement of the one or more parameters according to the user request to order;
receive a second set of user information relevant to the second user from the first user using the first set of one or more input devices and the second user using the second set of one or more input devices and determine a user class using the second set of user information;
receive a third set of user information relevant to the third user from the first user using the first set of one or more input devices and the third user using the third set of one or more input devices and determine a user class using the third set of user information;
determine format options for the first user based on the user class of the first user, the second user based on the user class of the second user, and the third user based on the user class of the third user; and
upon receiving a request from the first user using the first set of one or more input devices, the second user using the second set of one or more input devices, or the third user using the third set of one or more input devices to edit an item, set the user name parameter of the item using the user name of the first user, the user name of the second user, or the user name of the third user, respectively.

2. Claim 1, the first processor further programmed to:
receive a user request from the first user using the first set of one or more input devices to further format and display on the first display device a set of sub-parameters, a sub-parameter being a component of a parameter; and
receive a user selection from the first user using the first set of one or more input devices of one or more sub-parameters from the set of sub-parameters, receive a user request from the first user using the first set of one or more input devices to order the one or more sub-parameters from the user selection of the one or more sub-parameters, and display on the first display device an arrangement of the one or more sub-parameters according to the user request to order.

3. Claim 1, the second processor further programmed to receive a user selection from the second user using the second set of one or more input devices of a parameter, change a capitalization type of the parameter, and display the new capitalization type on the second display device, the capitalization type being one of the following: first letter upper case and remaining letters lower case, all letters upper case, and all letters lower case.

4. Claim 1, the third processor further programmed to receive a user selection from the third user using the third set of one or more input devices of a parameter, change a form type of the parameter, the new form type being displayed on the third display device, the form type being either numbers or letters.

5. Claim 1, the first processor further programmed to receive a user request from the first user using the first set of one or more input devices to demarcate the one or more parameters and display on the first display device one or more demarcations adjacent to the one or more parameters.

6. Claim 1, the first processor further programmed to receive a user request from the first user using the first set of one or more input devices to change a demarcation type of one or more demarcations, change the demarcation type, and display the new demarcation type on the first display device, the demarcation type being one of the following: a dash, slash, underscore, period, comma, colon, or parenthesis.

7. Claim 1, where a single user request from the second user to format concerns a single file and formatting is applied to the single file.

8. Claim 1, where a single user request from the first user to format concerns a set of ten or more files and formatting is applied to the set of ten or more files.

9. Claim 1, the second processor further programmed to determine whether the second user is permitted to format based on the user class of the second user.

10. Claim 1, where the user requests to order are effected by a drag-and-drop method.

11. Claim 1, the first processor further programmed to receive a user selection from the first user using the first set of input devices of a condition and an action, and if the condition is determined to occur, execute the action.

12. A system including a computer system, the computer system comprising a processor, a computer storage memory, a set of one or more input devices, and a display device, the computer system operated by a first user and a second user, the processor programmed to:
receive a first set of user information relevant to the first user from the first user using the set of one or more input devices and determine a user class using a first set of user information;
receive a second set of user information relevant to the second user from the first user using the set of one or more input devices and determine a user class using the second set of user information;
receive a user request from the first user using the set of one or more input devices to format and display on the display device a set of parameters, a parameter being a category of information appearing in a filename, the set of parameters including date, time, and username parameters;
receive a user request from the first user using the set of one or more input devices to order the one or more parameters from the user selection of the one or more parameters and display on the display device an arrangement of the one or more parameters according to the user request to order; and
upon receiving a request from the first user or the second user using the set of one or more input device to edit an item, set the user name parameter of the item using the user name of the first user or the user name of the second user, respectively.

13. Claim 12, the processor further programmed to:
receive a user request from the first user using the set of one or more input devices to further format and display on the display device a set of sub-parameters, a sub-parameter being a component of a parameter, the set of sub-parameters including day, month, and year sub-parameters; and
receive a user selection from the first user using the set of one or more input devices of one or more sub-parameters from the set of sub-parameters and a user request from the first user using the set of one or more input devices to order the one or more sub-parameters from the user selection and display an arrangement of the one or more sub-parameters according to the user request to order.

14. Claim 12, the processor further programmed to receive a user request from the first user using the set of one or more input devices to change a demarcation type of one or more demarcations, change the demarcation type, and display a new demarcation type on the display device.

15. Claim 12, where a single user request from the first user to format concerns a single file.

16. Claim 12, where a single user request from the first user to format concerns a set of ten or more files.

17. Claim 12, the processor further programmed to determine format options for the second user based on the user class of the second user.

18. Claim 12, where the user requests are effected by a drag-and-drop method using the set of one or more input devices.

19. Claim 12, the first processor further programmed to receive a user selection of a condition and an action, and if the condition is determined to occur, execute the action.

20. A system including a computer system, the computer system comprising a processor, a computer storage memory, a set of one or more input devices, and a display device, the computer system operated by user, the processor programmed to:
receive a user request from the user using the set of one or more input devices to format and display on the display device a set of parameters, a parameter being a category of information appearing in a filename, the set of parameters including date, time, and username parameters;
receive a user request from the user using the set of one or more input devices to further format and display on the display device a set of sub-parameters, a sub-parameter being a component of a parameter, the set of sub-parameters including day, month, and year sub-parameters, where the user request to further format concerns a set often or more files and formatting is applied to the set of ten or more files;
receive a user request from the user using the set of one or more input devices to order the one or more parameters and the one or more sub-parameters from the user selection of the one or more parameters and the one or more sub-parameters and display on the display device an arrangement of the one or more parameters and the one or more sub-parameters according to the user request to order, where the user request to format concerns a set of ten or more files and formatting is applied to the set of ten or more files; and
receive a user selection from the user using the set of one or more input devices of a condition from a set of conditions and an action from a set of actions, the set of conditions and the set of actions being displayed on the display device, and if the condition is determined to occur, execute the action.
